(19) United States
(12) Patent Application Publication
(10) Pub. No.: US 2017/0355091 A1
(43) Pub. Date: Dec. 14, 2017

(54) HOLLOW BOARD CUTTING APPARATUS

(71) Applicant: GMA MACHINERY ENTERPRISE CO., LTD, Taichung City (TW)

(72) Inventors: Chia-Hsi Hsu, Taichung City (TW); Che-Cheng Hsu, Taichung City (TW); Hsien-Chung Hsu, Taichung City (TW); Wen-Che Li, Taichung City (TW); Meng-Lin Liu, Taichung City (TW)

(21) Appl. No.: 15/178,059

(22) Filed: Jun. 9, 2016

(51) Int. Cl. B26D 5/08; B26D 7/26; B26D 7/00

(52) U.S. Cl. CPC B26D 5/086; B26D 7/0006; B26D 7/2614

(57) ABSTRACT

A hollow board cutting apparatus includes a machine bed unit, a driving unit, and a cutting unit. The driving unit includes a pair of upper sprockets rotatably disposed on the machine bed unit, a pair of lower sprockets rotatably disposed on the machine bed unit, a motor coupled to one of the lower sprockets for directly driving rotation of the one of the lower sprockets, a first drive chain trained on the upper and lower sprockets, and a second drive chain trained on the lower sprockets. The cutting unit includes an upper positioning seat coupled co-movably to the first drive chain, a lower positioning seat coupled co-movably to the second drive chain, and at least one cutting blade secured between the upper and lower positioning seats.

### FIELD

The disclosure relates to a cutting apparatus, and more particularly to a hollow board cutting apparatus.

### BACKGROUND

Referring to FIG. 1, a conventional cutting apparatus includes a rail 1, a driving unit 2 configured as a chain-sprocket mechanism (only a portion of the chain is illustrated in FIG. 1), a positioning seat 3 coupled co-movably to the driving unit 2, and a cutting blade 4 secured on the positioning seat 3. The driving unit 2 drives the positioning seat 3 to slide along the rail 1, so that the cutting blade 4 can perform cutting action on a workpiece (not shown).

However, when the conventional cutting apparatus is operated at a relatively high speed, the cutting blade 4 may not be steady and may bend easily due to a resistance force generated by the cutting action. As a result, the workpiece cut by the conventional cutting apparatus may have an unlevel cut edge. To solve such problem, thickness of the cutting blade 4 may be increased, but doing so increases the resistance force, which may result in tearing of the workpiece or distortion of the cut edge of the workpiece, thereby adversely affect the quality of the workpiece.

### SUMMARY

Therefore, an object of the disclosure is to provide a hollow board cutting apparatus that can alleviate at least one of the drawbacks of the prior art.

According to the disclosure, the hollow board cutting apparatus includes a machine bed unit, a driving unit, and a cutting unit. The driving unit includes a pair of upper sprockets that are rotatably disposed on the machine bed unit, a pair of lower sprockets that are disposed rotatably on the machine bed unit, a motor that is coupled to one of the lower sprockets for directly driving rotation of the one of the lower sprockets, a first drive chain that is trained on the upper sprockets and the lower sprockets, and a second drive chain that is trained on the lower sprockets. The cutting unit includes an upper positioning seat that is coupled co-movably to the first drive chain, a lower positioning seat that is coupled co-movably to the second drive chain, and at least one cutting blade that is secured between the upper and lower positioning seats.

### BRIEF DESCRIPTION OF THE DRAWINGS

Other features and advantages of the disclosure will become apparent in the following detailed description of the embodiment with reference to the accompanying drawings, of which:

FIG. 1 is a schematic perspective view of a conventional cutting apparatus;

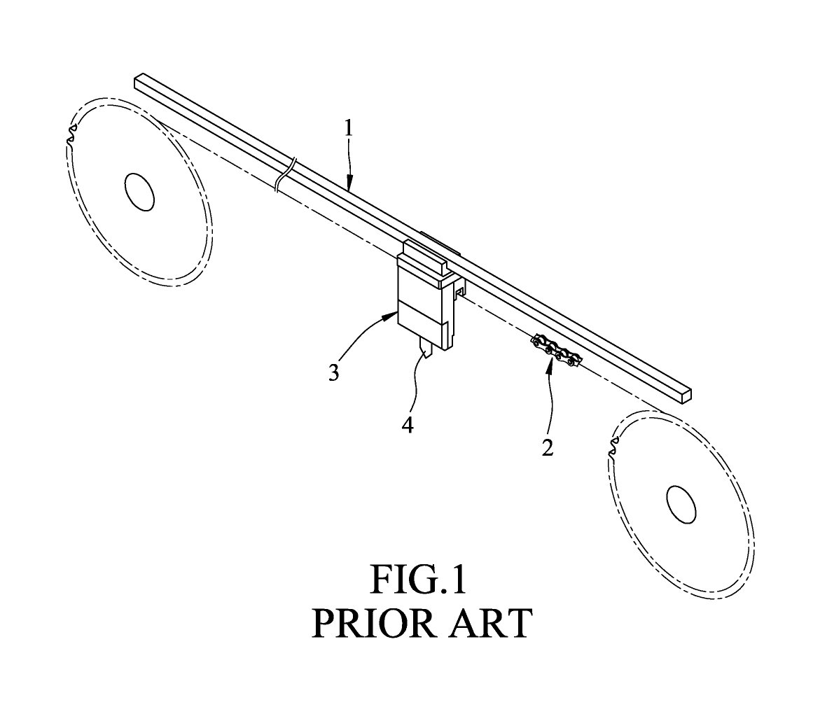

FIG. 2 is a perspective view of an embodiment of a hollow board cutting apparatus according to the disclosure;

FIG. 3 is a schematic perspective view illustrating an upper rail, a lower rail, a driving unit, and a cutting unit of the embodiment; and

FIG. 4 is an exploded perspective view of the cutting unit of the embodiment.

### DETAILED DESCRIPTION

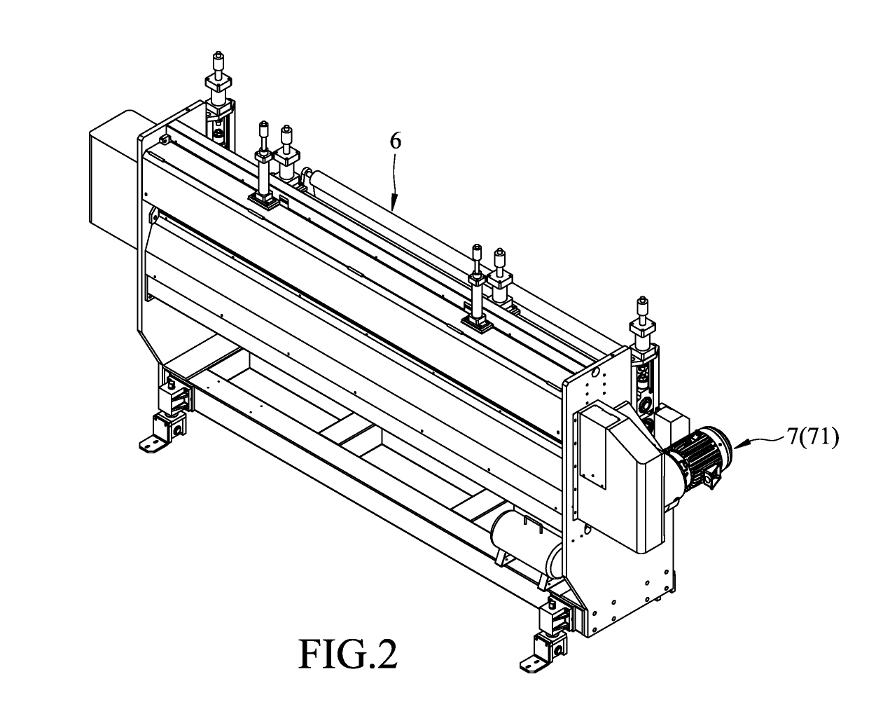

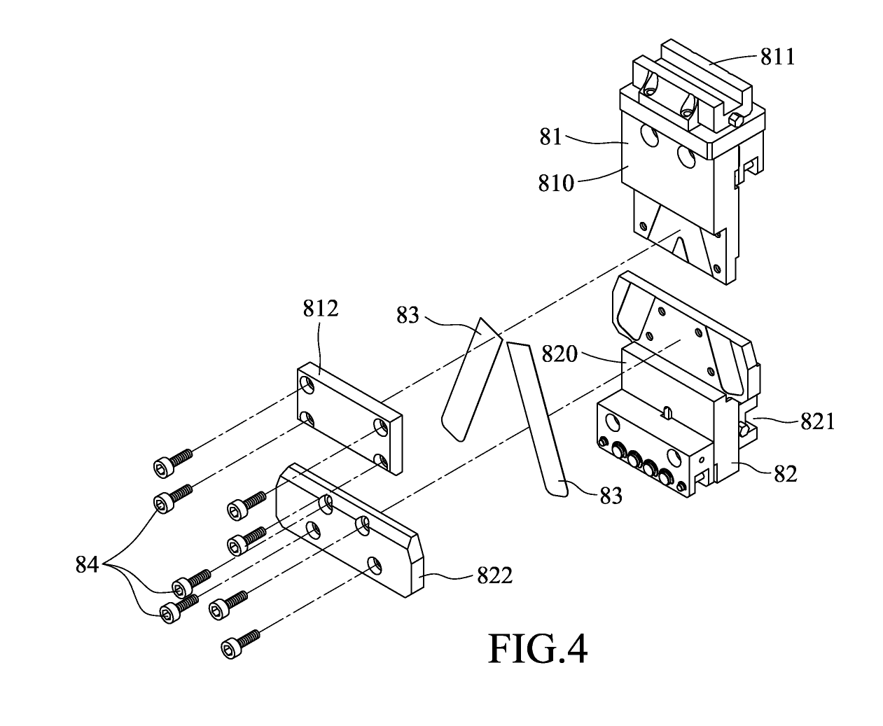

Referring to FIGS. 2 to 4, an embodiment of a hollow board cutting apparatus according to the disclosure is for cutting a workpiece (not shown), such as a hollow board. The hollow board cutting apparatus includes a machine bed unit 6, a driving unit 7, and a cutting unit 8.

The machine bed unit 6 includes an upper rail 61 and a lower rail 62.

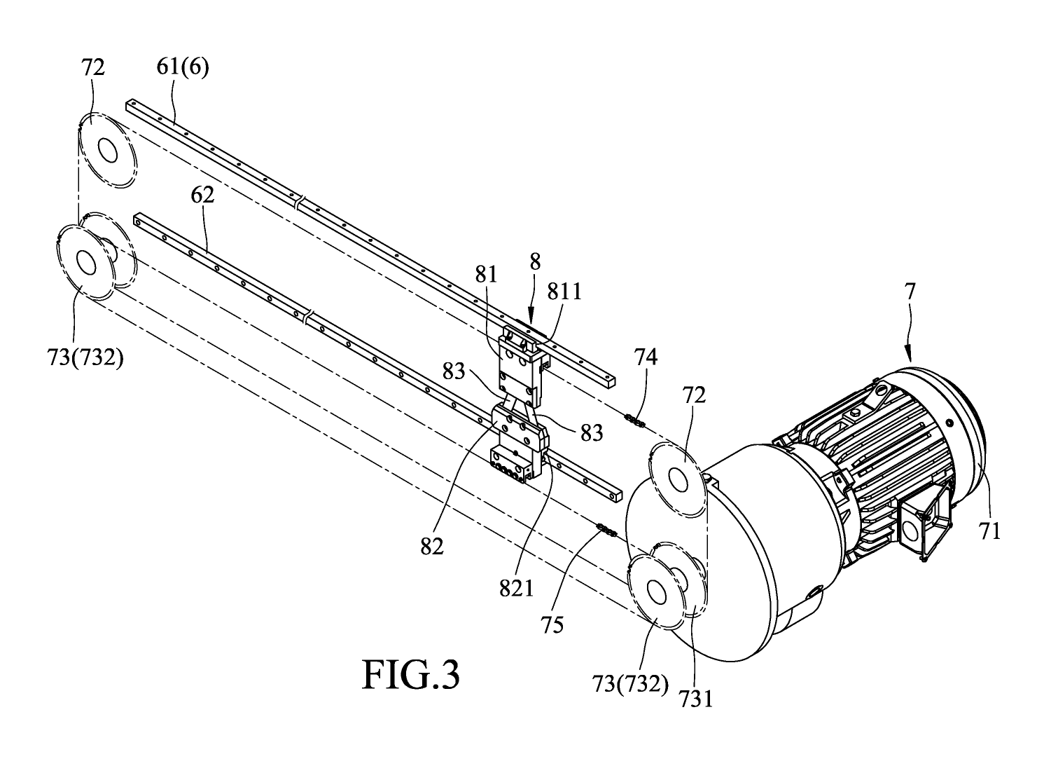

The driving unit 7 includes a pair of upper sprockets 72, a pair of lower sprockets 73, a motor 71, a first drive chain 74, and a second drive chain 75 (only a portion of the first drive chain 74 and a portion of the second drive chain 75 are illustrated in FIG. 3).

The upper sprockets 72 are rotatably disposed on the machine bed unit 6. The lower sprockets 73 are rotatably disposed on the machine bed unit 6. Each of the lower sprockets 73 has a first sprocket portion 731, and a second sprocket portion 732 co-axially and co-rotatably connected to the first sprocket portion 731. The motor 71 is coupled to one of the lower sprockets 73 for directly driving rotation of the one of the lower sprockets 73. The first drive chain 74 is trained on the upper sprockets 72 and the first sprocket portion 731 of each of the lower sprockets 73. The second drive chain 75 is trained on the second sprocket portion 732 of each of the lower sprockets 73.

The cutting unit 8 includes an upper positioning seat 81, a lower positioning seat 82, two cutting blades 83, and a plurality of fastening members 84.

The upper positioning seat 81 is coupled co-movably to the first drive chain 74, and has a main body 810 formed with an upper slide groove 811 that opens upwardly and that is slidably engaged with the upper rail 61.

The lower positioning seat 82 is coupled co-movably to the second drive chain 75, and has a main body 820 formed with a lower slide groove 821 that opens laterally and that is slidably engaged with the lower rail 62.

The cutting blades 83 are secured between the upper and lower positioning seats 81, 82. In certain embodiments, the cutting unit 8 may only include one cutting blade 83.

The upper positioning seat 81 further has an upper press board 812, and the lower positioning seat 82 further has a lower press board 822. The fastening members 84 detachably fasten the upper press board 812 to the main body 810 of the upper positioning seat 81 so as to clamp upper portions of the cutting blades 83 therebetween, and detachably fasten the lower press board 822 to the main body 820 of the lower positioning seat 82 so as to clamp lower portions of the cutting blades 83 therebetween, so that the cutting blades 83 are confined between the upper and lower positioning seats 81, 82.

During operation, the motor 71 directly drives rotation of the one of the lower sprockets 73 which is coupled to the motor 71. The first sprocket portion 731 of the one of the lower sprockets 73 drives movement of the first drive chain 74 so as to drive the upper positioning seat 81 to slide along the upper rail 61. The second sprocket portion 732 of the one of the lower sprockets 73 drives movement of the second drive chain 75 so as to drive the lower positioning seat 82 to slide along the lower rail 62. Since the first sprocket portion 731 and the second sprocket portion 732 of the one of the lower sprockets 73 are co-axially connected and rotate at the same speed, the upper and lower positioning seats 81, 82 respectively slide along the upper and lower rails 61, 62 in a synchronous manner so as to permit the cutting blades 83 to perform cutting action.

In summary, since the cutting blades 83 are firmly secured between the upper and lower positioning seats 81, 82, and since the upper and lower positioning seats 81, 82 are driven to slide in a synchronous manner, a relatively steady cutting operation is achieved compared with the above-mentioned conventional cutting apparatus having only one positioning seat 3. In this way, the workpiece that is cut using the hollow board cutting apparatus of the disclosure has a relatively level cut edge. Furthermore, by virtue of the upper and lower positioning seats 81, 82, the cutting blades 83 can be designed to have a relatively small thickness, thereby preventing the occurrences of tearing of the workpiece and distortion of the cut edge of the workpiece.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A hollow board cutting apparatus comprising:
a machine bed unit;
a driving unit including a pair of upper sprockets that are rotatably disposed on said machine bed unit, a pair of lower sprockets that are rotatably disposed on said machine bed unit, a motor that is coupled to one of said lower sprockets for directly driving rotation of said one of said lower sprockets, a first drive chain that is trained on said upper sprockets and said lower sprockets, and a second drive chain that is trained on said lower sprockets; and
a cutting unit including an upper positioning seat that is coupled co-movably to said first drive chain, a lower positioning seat that is coupled co-movably to said second drive chain, and at least one cutting blade that is secured between said upper and lower positioning seats.

2. The hollow board cutting apparatus as claimed in claim 1, wherein:
each of said lower sprockets has a first sprocket portion and a second sprocket portion co-axially connected to said first sprocket portion;
said first drive chain is trained on said upper sprockets and said first sprocket portion of each of said lower sprockets; and
said second drive chain is trained on said second sprocket portion of each of said lower sprockets.

3. The hollow board cutting apparatus as claimed in claim 2, wherein:
said machine bed unit includes an upper rail and a lower rail;
said upper positioning seat of said cutting unit has an upper slide groove that is slidably engaged with said upper rail; and
said lower positioning seat has a lower slide groove that is slidably engaged with said lower rail.

4. The hollow board cutting apparatus as claimed in claim 3, wherein:
said upper slide groove opens upwardly; and
said lower slide groove opens laterally.

5. The hollow board cutting apparatus as claimed in claim 1, wherein said cutting unit includes a plurality of said cutting blades.

6. The hollow board cutting apparatus as claimed in claim 1, wherein:
said upper positioning seat has a main body and an upper press board;
said lower positioning seat has a main body and a lower press board; and
said cutting unit further includes a plurality of fastening members detachably fastening said upper and lower press boards to said main bodies of said upper and lower positioning seats, respectively, so as to confine said at least one cutting blade between said upper and lower positioning seats.
